(19) United States
(12) Patent Application Publication
(10) Pub. No.: US 2026/0324583 A1
(43) Pub. Date: Oct. 22, 2026

(54) CAT LITTER BOX

(71) Applicant: UBTECH ROBOTICS CORP LTD, Shenzhen (CN)

(72) Inventors: FAN YANG, Shenzhen (CN); Yudong Liu, Shenzhen (CN); Xinshui Huang, Shenzhen (CN); Mingming JI, Shenzhen (CN); Jin Li, Shenzhen (CN)

(21) Appl. No.: 19/705,869

(22) Filed: Jun. 12, 2026

Related U.S. Application Data
(63) Continuation of application No. PCT/CN2024/078526, filed on Feb. 26, 2024.
(63) Continuation of application No. PCT/CN2024/089518, filed on Apr. 24, 2024.

(30) Foreign Application Priority Data
Dec. 12, 2023 (CN) 202323392308.9
Apr. 22, 2024 (CN) 202410482585.9

(51) Int. Cl. A01K 1/01

(52) U.S. Cl. CPC A01K 1/0114

(57) ABSTRACT

A cat litter box includes a base and a drum rotatably disposed on the base. The drum defines an accommodating cavity. A circumferential sidewall of the drum defines an opening communicating with the accommodating cavity. In a plane perpendicular to a rotation axis of the drum, a first opening angle of the opening is α, and in a plane where the rotation axis of the drum is located, a second opening angle of the opening is β: 70°≤α≤120°, and 70°≤β≤120°.

### CROSS-REFERENCE TO RELATED APPLICATION

The present disclosure is a continuation-in-part of International Patent Application No. PCT/CN 2024/078526 filed on Feb. 26, 2024, which further claims foreign priority to Chinese patent application No. CN 202323392308.9 filed on Dec. 12, 2023, and the entire contents of which are hereby incorporated by reference. The present disclosure is also a continuation-in-part of International Patent Application No. PCT/CN2024/089518 filed on Apr. 24, 2024, which further claims foreign priority to Chinese patent application No CN 202410482585.9 filed on Apr. 22, 2024, and the entire contents of which are hereby incorporated by reference.

### TECHNICAL FIELD

The present disclosure relates to a technical field of pet products, and in particular to a cat litter box.

### BACKGROUND

The information disclosed in Background is only intended to deepen the understanding of the general background of the present disclosure and should not be taken as an acknowledgment or any form of implication that this information constitutes prior art well known to those skilled in the art.

Automatic cat litter boxes are exceptionally convenient devices for cat owners to clean up cat litter and waste. The cat owners are able to remove the cat litter and waste by simply pressing a cleaning button to complete a cleaning process and then opening a compartment door at an opening of a drum, which makes it even easier and more convenient to raise the cats.

In the related art, a drum of a cat litter box has an opening at one side perpendicular its rotation axis (i.e., at an end portion of the drum). Due to constraints imposed by a structure of the end portion of the drum, a size of the opening is limited, and a field of view is narrow, which makes it inconvenient for cat owners to add cat litter and for the cats to enter and exit the drum.

### SUMMARY

In view of this, an object of the present disclosure is to provide a cat litter box, aiming to solve technical problems in the related art where a size of an opening of a conventional cat litter box is limited and a field of view defined by the opening is narrow. In the present disclosure, the cat litter box is convenient for a user to add cat litter and is convenient for a cat to enter and exit the drum.

To achieve the object, the present disclosure provides a cat litter box. The cat litter box comprises a base and a drum rotatably disposed on the base. The drum defines an accommodating cavity. A circumferential sidewall of the drum defines an opening communicating with the accommodating cavity.

In a plane perpendicular to a rotation axis of the drum, a first opening angle of the opening is α, and in a plane where the rotation axis of the drum is located, a second opening angle of the opening is β: 70°≤α≤120°, and 70°≤β≤120°.

In one embodiment, a flange is disposed along a circumferential direction of the opening, the flange is smoothly connected to an edge of the opening, and the flange extends in a direction toward the accommodating cavity.

In one embodiment, first reinforcing ribs are spaced apart from each other along the circumferential direction of the opening, and each of the plurality of first reinforcing ribs is connected between the flange and a cavity wall of the accommodating cavity.

In one embodiment, the flange comprises a first flange portion and a second flange portion, the first flange portion is of a U shape, the second flange portion is configured for a pet to step on, the first flange portion is smoothly connected to the second flange portion, and an extension distance of the second flange portion in the direction toward the accommodating cavity is greater than an extension distance of the first flange portion in the direction toward the accommodating cavity.

In one embodiment, the extension distance of the first flange portion in the direction toward the accommodating cavity is L₁, and 8 mm≤L₁≤18 mm.

In one embodiment, the extension distance of the second flange portion in the direction toward the accommodating cavity is L₂, and 25 mm≤L₂≤50 mm.

In one embodiment, the edge of the opening comprises a first edge portion, a second edge portion, a third edge portion, and a fourth edge portion, the first edge portion and the second edge portion are disposed opposite to each other, the third edge portion and the fourth edge portion are disposed opposite to each other, the third edge portion is smoothly connected between the first edge portion and the second edge portion, and the fourth edge portion is smoothly connected between the first edge portion and the second edge portion.

In one embodiment, each of the third edge portion and the fourth edge portion is arched in a direction away from the accommodating cavity.

In one embodiment, a portion of the first edge portion away from the second edge portion, a portion of the third edge portion away from the second edge portion, and a portion of the fourth edge portion away from the second edge portion enclose to form a first U-shaped structure; or a portion of the second edge portion away from the first edge portion, a portion of the third edge portion away from the first edge portion, and a portion of the fourth edge portion away from the first edge portion enclose to form a second U-shaped structure.

In one embodiment, a second reinforcing rib is disposed along a circumferential direction of the opening, the second reinforcing rib is smoothly connected to the edge of the opening, and the second reinforcing rib extends in a direction away from the accommodating cavity.

The cat litter box of the present disclosure comprises the base and the drum. By defining the opening on the circumferential sidewall of the drum, the circumferential sidewall of the drum provides sufficient area for the opening, and the drum can be designed longer to expand the width of the opening. On this basis, the first opening angle α of the opening in the plane perpendicular to the rotation axis of the drum is within a range of 70° to 120°, and the second opening angle β of the opening in the plane where the rotation axis of the drum is located is within a range of 70° to 120°. In this way, the opening is large relative to the accommodating cavity, making it more convenient for the cat to enter and exit the drum, provides a wider field of view, making it easier for the user to add cat litter, and enhances the market competitiveness of the cat litter box.

To make the aforementioned objects, features, and technical effects of the present disclosure more apparent and easier to understand, preferred embodiments are described below and described in detail in conjunction with the accompanying drawings.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of a drum according to some embodiments of the present disclosure.

FIG. 2 is another schematic diagram of the drum according to some embodiments of the present disclosure.

FIG. 3 is another schematic diagram of the drum according to some embodiments of the present disclosure.

FIG. 4 is another schematic diagram of the drum according to some embodiments of the present disclosure.

FIG. 5 is another schematic diagram of the drum according to some embodiments of the present disclosure.

FIG. 6 is an enlarged schematic diagram of portion A shown in FIG. 5.

FIG. 7 is a perspective schematic diagram of a cat litter box according to one embodiment of the present disclosure.

FIG. 8 is an exploded schematic diagram of the cat litter box according to one embodiment of the present disclosure.

FIG. 9 is a cross-sectional schematic diagram of the cat litter box according to one embodiment of the present disclosure.

FIG. 10 is a perspective schematic diagram of a partition assembly according to one embodiment of the present disclosure.

FIG. 11 is a perspective schematic diagram of a litter sieve and an emptying plate according to one embodiment of the present disclosure.

FIG. 12 is a perspective schematic diagram of a base according to one embodiment of the present disclosure.

### DETAILED DESCRIPTION

Embodiments of the present disclosure are described in detail below. Examples of the embodiments are shown in the accompanying drawings, in which the same or similar reference numerals indicate the same or similar elements or elements with the same or similar functions. The embodiments described below with reference to the drawings are exemplary, and are intended to explain the present disclosure, but should not be regarded as a limitation on the present disclosure.

It should be understood that in the description of the present disclosure, terms such as “central”, “lateral”, “lengthways”, “length”, “width”, “thickness”, “upper”, “lower”, “left”, “right”, “vertical”, “horizontal”, “top”, “bottom”, “inner”, “outer”, “clockwise”, “counterclockwise”, etc. indicate direction or position relationships shown based on the drawings, and are only intended to facilitate the description of the present disclosure and the simplification of the description rather than to indicate or imply that the indicated device or element must have a specific direction or be constructed and operated in a specific direction; and therefore, shall not be understood as a limitation to the present disclosure.

In addition, terms such as “first” and “second” are only used for the purpose of description, rather than being understood to indicate or imply relative importance or hint at the number of indicated technical features. Thus, the feature limited by “first” and “second” can explicitly or implicitly include one or more features. In the description of the present disclosure, the meaning of “a plurality of” is two or more, unless otherwise specified.

It should be noted in the description of the present disclosure that, unless otherwise regulated and defined, terms such as “installation,” “bonded,” and “connection” shall be understood in a broad sense, and, for example, may refer to a fixed connection or a detachable connection or an integral connection; may refer to a mechanical connection or an electrical connection; and may refer to a direct connection or an indirect connection through an intermediate medium or inner communication between two elements. For those of ordinary skill in the art, the meanings of the above terms in the present disclosure may be understood according to concrete conditions.

In the present disclosure, unless expressly stipulated and defined otherwise, the first feature is arranged “above” or “below” the second feature, which may mean that the first feature directly contacts the second feature, or the first feature does not directly contact the second feature but is connected with the second feature through other features between them. Furthermore, the first feature is arranged “on”, “above”, or “over” the second feature, which means that the first feature may be arranged directly above and obliquely above the second feature, or it may merely indicate that a level of the first feature is greater than a level of the second feature. The first feature is arranged “below”, “under”, and “beneath” the second feature means that the first feature is arranged directly below and obliquely below the second feature, or it simply means that the level of the first feature is less than the level of the second feature.

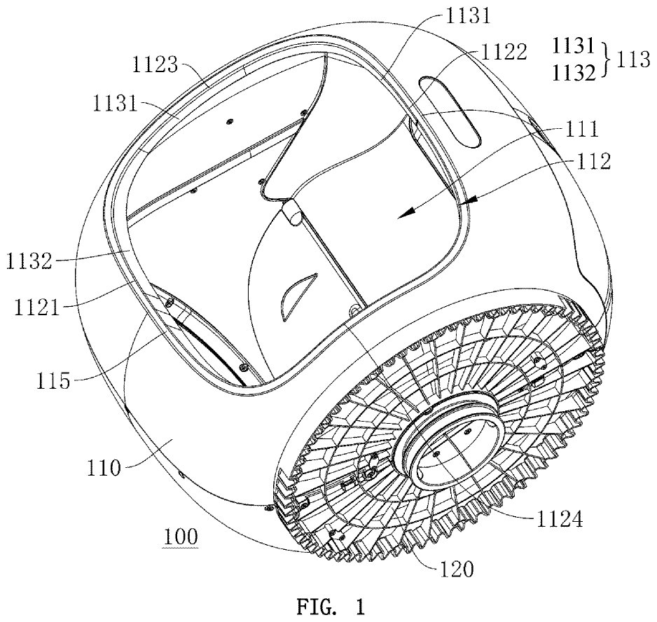

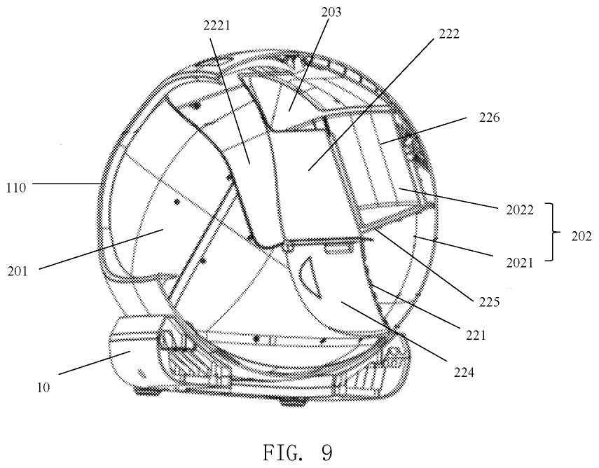

As shown in FIGS. 1-12, embodiments of the present disclosure provide a cat litter box, which is related to a technical field of pet products. The cat litter box comprises a base 10 and a drum 100.

The drum 100 is substantially cylindrical and is rotatably disposed on the base 10 The drum 100 defines an accommodating cavity 111. The accommodating cavity 111 is configured for placing cat litter and providing an activity space for a pet. A circumferential sidewall of the drum 100 defines an opening 112 communicating with the accommodating cavity 111. In a plane perpendicular to a rotation axis H of the drum 100, a first opening angle of the opening 112 is α. In a plane of the rotation axis H of the drum 100, a second opening angle of the opening 112 is β. 70°≤α≤120° and 70°≤β≤120°.

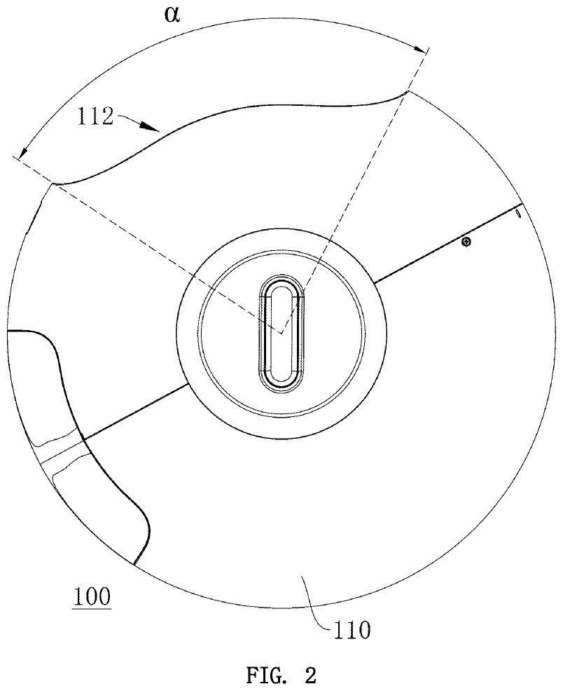

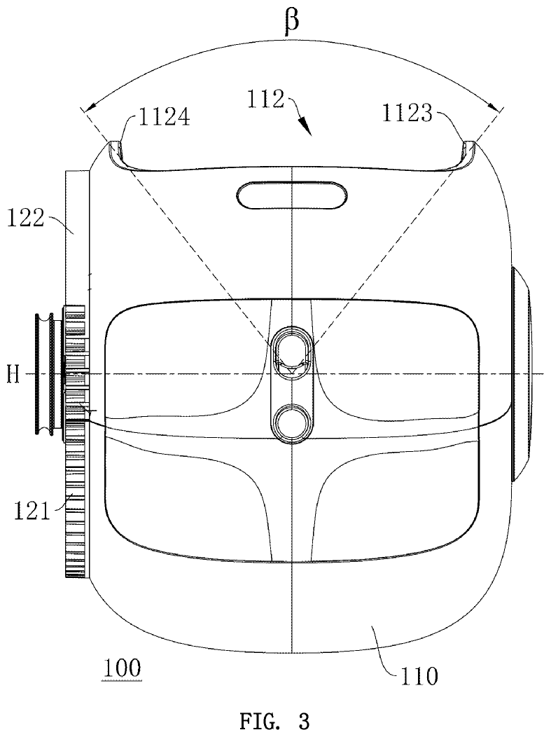

It should be noted that, as shown in FIG. 2, in the plane perpendicular to the rotation axis H of the drum 100 and crossing the center of the opening 112, two auxiliary lines are drawn from the rotation axis H to two edges of the opening 112, and the included angle between the two auxiliary lines is denoted as the first opening angle α of the opening 112. As shown in FIG. 3, in the plane of the rotation axis H of the drum 100, two auxiliary lines are drawn from the rotation axis H to another two edges of the opening 112, and the included angle between the two auxiliary lines is denoted as the second opening angle β of the opening 112.

Specifically, the first opening angle α is selected from 70°, 72°, 75°, 75.5°, 78°, 80°, 84°, 90°, 98°, 100°, 110°, 115°, 120°, etc. The second opening angle β is selected from 70°, 72°, 75°, 75.5°, 78°, 80°, 83°, 83.5°, 84°, 90°, 98°, 100°, 110°, 115°, 120°, etc. Preferably, the opening angles α and β are 75° and 98°, respectively.

In the related art, a drum of a conventional cat litter box defines an opening at an end portion of the drum that is perpendicular to a plane of its rotation axis. Due to constraints imposed by a structure of the end portion of the drum of the conventional cat litter box, a size of the opening of the conventional cat litter box is limited, and the field of view is narrow, making it inconvenient for a user to add cat litter and for the pet to enter and exit the drum.

It is understood that, in the cat litter box provided by the embodiment, by defining the opening 112 on the circumferential sidewall of the drum 100, the circumferential sidewall of the drum 100 has a sufficient area to form the opening 112. On this basis, the first opening angle α of the opening 112 in the plane perpendicular to the rotation axis H of the drum 100 is within a range of 70° to 120°, and the second opening angle β of the opening 112 in the plane where the rotation axis H of the drum 100 is located is within a range of 70° to 120°. In this way, the opening 112 has a relatively large space relative to the accommodating cavity 111, which makes it more convenient for the pet to enter and exit the drum 100, making it easier for the user to add cat litter, and provides a wider field of view, thereby enhancing the market competitiveness of the cat litter box of the present disclosure.

As shown in FIG. 1, in one embodiment, a flange 113 is disposed along a circumferential direction of the opening 112. The flange 113 is smoothly connected to an edge of the opening 112, and the flange 113 extends in a direction toward the accommodating cavity 111.

In the embodiment, the flange 113 is disposed along the circumferential direction of the opening 112, and the flange 113 is smoothly connected to the edge of the opening 112 and extends in the direction toward the accommodating cavity 111. In this way, on the one hand, when the edge of the opening 112 has a tendency to deform, since the flange 113 has relatively high structural strength and is capable of maintaining its own original shape, the flange 113 can exert a fixing stress on the edge of the opening 112 to counteract deformation stress generated at the edge of the opening 112, thereby limiting deformation of the edge of the opening 112 and effectively improving structural stability of the drum 100. On the other hand, the flange 113 is received within the accommodating cavity 111, making an outer shape of the drum 100 more rounded and aesthetically pleasing, which enhances market competitiveness of the cat litter box.

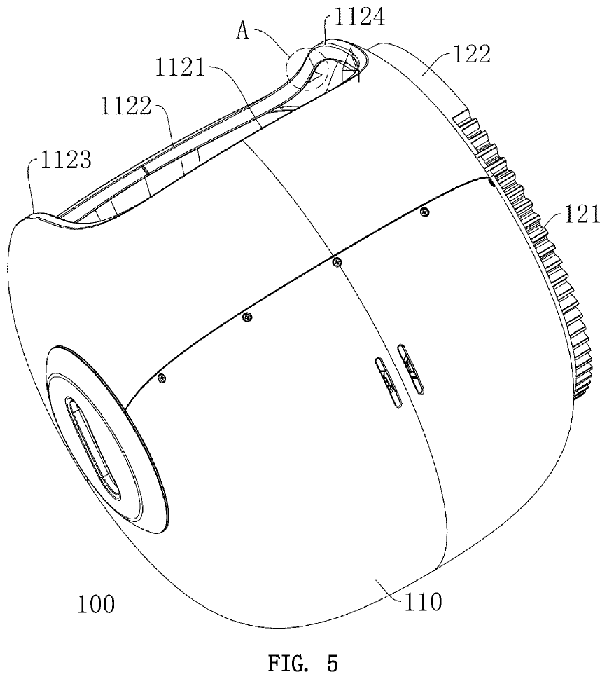

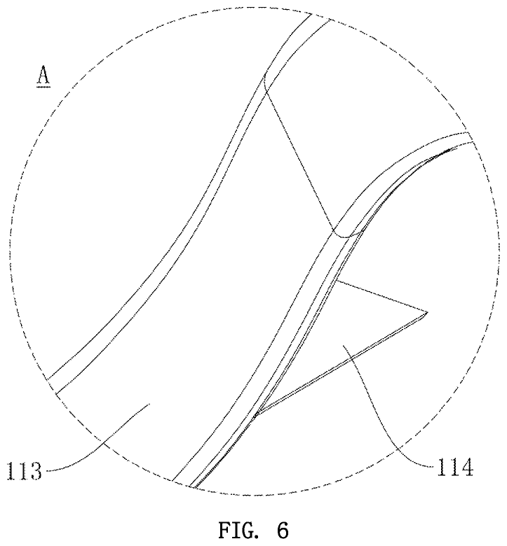

Furthermore, as shown in FIG. 5 and FIG. 6, first reinforcing ribs 114 are spaced apart from each other along the circumferential direction of the opening 112, and each of the first reinforcing ribs 114 is connected between the flange 113 and a cavity wall of the accommodating cavity 111.

Specifically, the number of the first reinforcing ribs 114 may be selected from two, three, four, five, etc, which is specifically determined according to design requirements.

In the embodiment, by spacing the first reinforcing ribs 114 apart from each other along the circumferential direction of the opening 112, since the first reinforcing ribs 114 have relatively high structural strength, when the flange 113 has a tendency to deform, the first reinforcing ribs 114 exert a fixing stress on the flange 113 to counteract deformation stress generated by the deformation of the flange 113 so as to limit the deformation of the flange 113, thereby further improving structural stability of the drum 100.

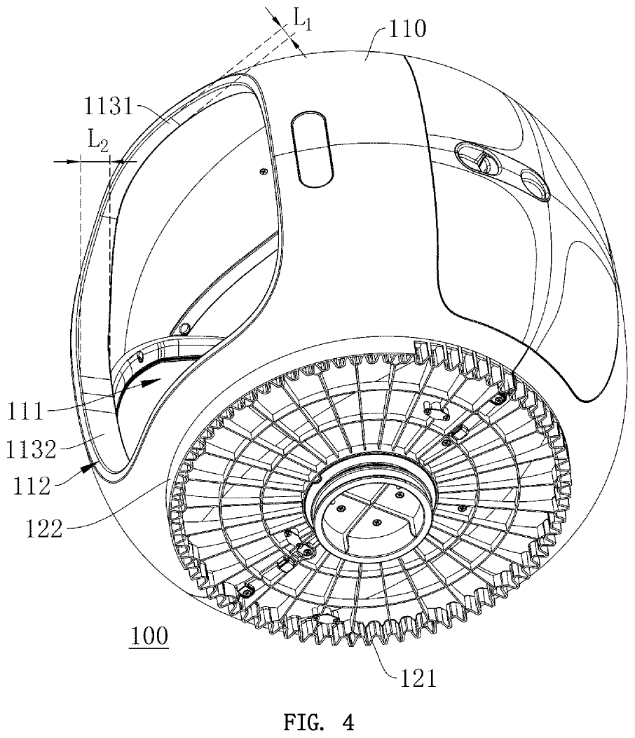

Furthermore, as shown in FIG. 1 and FIG. 4, the flange 113 comprises a first flange portion 1131 and a second flange portion 1132. The second flange portion 1132 is configured for the pet to step on. The first flange portion 1131 has a U shape. The first flange portion 1131 is smoothly connected to the second flange portion 1132. An extension distance of the second flange portion 1132 in the direction toward the accommodating cavity 111 is greater than an extension distance of the first flange portion 1131 in the direction toward the accommodating cavity 111.

In the embodiment, by configuring the first flange portion 1131 as a U-shaped structure and smoothly connecting the first flange portion 1131 to the second flange portion 1132, an outer shape of the flange 113 is made more rounded and aesthetically pleasing. On this basis, the extension distance of the second flange portion 1132 in the direction toward the accommodating cavity 111 is made greater than the extension distance of the first flange portion 1131 in the direction toward the accommodating cavity 111, so that it is convenient for the pet to step on the second flange portion 1132 to enter and exit the drum 100.

Furthermore, as shown in FIG. 4, the extension distance of the first flange portion 1131 in the direction toward the accommodating cavity 111 is defined as L₁. 8 mm≤L₁≤18 mm.

Specifically, L₁ is selected from 8 mm, 8.2 mm, 8.5 mm, 9 mm, 9.6 mm, 10 mm, 10.2 mm, 10.5 mm, 11 mm, 12 mm, 14 mm, 16 mm, 17 mm, 18 mm, etc. When the first flange portion 1131 is a sheet structure, L₁ refers to a width of the first flange portion 1131.

It should be pointed out that if L₁ is too small, it is inconvenient for a foot of the pet step on, and at the same time, a reinforcing effect of the first flange portion 1131 on the edge of the opening 112 is insufficient. If L₁ is too large, it may cause waste of materials and may increase manufacturing costs, and the first flange portion 1131 may occupy too much space of the accommodating cavity 111, indirectly reducing a capacity of the accommodating cavity 111.

In the embodiment, the extension distance L₁ of the first flange portion 1131 in the direction toward the accommodating cavity 111 is controlled within a range of 8 mm to 18 mm, so that the extension distance L₁ is adapted to a foot size of the pet. Thus, the pet is able to step on the first flange portion 1131 to enter and exit the drum 100. At the same time, an occupancy of the space of the accommodating cavity 111 by the first flange portion 1131 is reduced.

Furthermore, as shown in FIG. 4, the extension distance of the second flange portion 1132 in the direction toward the accommodating cavity 111 is defined as L₂, 25 mm≤L₂≤50 mm.

Specifically, L₂ is selected from 25 mm, 26 mm, 28 mm, 29.5 mm, 30 mm, 30.5 mm, 31 mm, 35 mm, 40 mm, 42 mm, 45 mm, 49 mm, 50 mm, etc. When the second flange portion 1132 is a sheet structure, L₂ refers to a width of the second flange portion 1132.

It should be pointed out that if L₂ is too small, it may lead to an insufficient reinforcing effect of the second flange portion 1132 on the edge of the opening 112. If L₂ is too large, it may cause waste of materials and increase manufacturing costs, and the second flange portion 1132 may occupy too much space of the accommodating cavity 111, indirectly reducing the capacity of the accommodating cavity 111.

In the embodiment, the extension distance L₂ of the second flange portion 1132 in the direction toward the accommodating cavity 111 is controlled within a range of 25 mm to 50 mm, so that not only can a sufficient reinforcing effect be achieved on the edge of the opening 112, but also an occupancy of the space of the accommodating cavity 111 by the second flange portion 1132 is reduced, thereby increasing an actual capacity of the accommodating cavity 111.

In another embodiment, the flange 113 comprises flange portions. The flange portions are spaced apart from each other along the circumferential direction of the opening 112. Each of the flange portions is smoothly connected to the edge of the opening 112, which also reinforces the edge of the opening 112, so as to improve the structural strength and structural stability of the drum 100.

As shown in FIG. 1, in one embodiment, the edge of the opening 112 comprises a first edge portion 1121, a second edge portion 1122, a third edge portion 1123, and a fourth edge portion 1124. The first edge portion 1121 and the second edge portion 1122 are disposed opposite to each other. The third edge portion 1123 and the fourth edge portion 1124 are disposed opposite to each other. The third edge portion 1123 is smoothly connected between the first edge portion 1121 and the second edge portion 1122. The fourth edge portion 1124 is smoothly connected between the first edge portion 1121 and the second edge portion 1122.

In the embodiment, by sequentially and smoothly connecting the first edge portion 1121, the third edge portion 1123, the second edge portion 1122, and the fourth edge portion 1124 to form the opening 112 that is rounded and approximately square, it is not only convenient for the pet to enter and exit the drum 100 and for the user to add the cat litter, but also offers greater aesthetic appeal, thereby enhancing the ornamental value of the cat litter box.

Furthermore, as shown in FIG. 5, each of the third edge portion 1123 and the fourth edge portion 1124 is arched in a direction away from the accommodating cavity 111. In this way, an actual capacity of the accommodating cavity 111 increases, and an edge shape of the opening 112 is undulant, thereby enhancing the ornamental value of the cat litter box.

Of course, with respect to the aforementioned embodiment, it is also applicable that each of the first edge portion 1121 and the second edge portion 1122 is arched in a direction away from the accommodating cavity 111.

Furthermore, as shown in FIG. 1, the first edge portion 1121, a portion of the third edge portion 1123 away from the second edge portion 1122, and a portion of the fourth edge portion 1124 away from the second edge portion 1122 enclose to form a first U-shaped structure; and/or the second edge portion 1122, a portion of the third edge portion 1123 away from the first edge portion 1121, and a portion of the fourth edge portion 1124 away from the first edge portion 1121 enclose to form a second U-shaped structure.

Specifically, the first edge portion 1121, the portion of the third edge portion 1123 away from the second edge portion 1122, and the portion of the fourth edge portion 1124 away from the second edge portion 1122 enclose to form the first U-shaped structure, and the second edge portion 1122, the portion of the third edge portion 1123 away from the first edge portion 1121, and the portion of the fourth edge portion 1124 away from the first edge portion 1121 enclose to form the second U-shaped structure. In this way, the two U-shaped structures form a rounded runway-shaped edge of the opening 112, which is not only convenient for the pet to enter and exit the drum 100 and for the user to add the cat litter, but also offers greater aesthetic appeal, thereby enhancing the ornamental value of the cat litter box.

Of course, it is also applicable that the first edge portion 1121, the portion of the third edge portion 1123 away from the second edge portion 1122, and the portion of the fourth edge portion 1124 away from the second edge portion 1122 enclose to form the first U-shaped structure, while the second edge portion 1122, the portion of the third edge portion 1123 away from the first edge portion 1121, and the portion of the fourth edge portion 1124 away from the first edge portion 1121 enclose to form a V-shaped structure or a C-shaped structure.

In addition, it is also applicable that the second edge portion 1122, the portion of the third edge portion 1123 away from the first edge portion 1121, and the portion of the fourth edge portion 1124 away from the first edge portion 1121 enclose to form the second U-shaped structure, while the first edge portion 1121, the portion of the third edge portion 1123 away from the second edge portion 1122, and the portion of the fourth edge portion 1124 away from the second edge portion 1122 enclose to form the V-shaped structure or the C-shaped structure.

In another embodiment, the edge of the opening 112 may have a triangular structure, hexagonal structure, an elliptical structure, a circular structure, etc., and a shape of the edge of the opening 112 is not specifically limited thereto.

As shown in FIG. 1, in one embodiment, a second reinforcing rib 115 is disposed along the circumferential direction of the opening 112. The second reinforcing rib 115 is smoothly connected to the edge of the opening 112 and extends in the direction away from the accommodating cavity 111.

In the embodiment, the second reinforcing rib 115 is disposed along the circumferential direction of the opening 112, and the second reinforcing rib 115 is smoothly connected to the edge of the opening 112 and extends in the direction away from the accommodating cavity 111. In this way, when the edge of the opening 112 has a tendency to deform, since the second reinforcing rib 115 has relatively high structural strength and is capable of maintaining its own original shape, the second reinforcing rib 115 exerts a fixing stress on the edge of the opening 112 to counteract the deformation stress generated at the edge of the opening 112, thereby limiting the deformation of the edge of the opening 112 and effectively improving the structural stability of the drum 100.

It should be noted that both the flange 113 and the second reinforcing rib 115 are disposed at the opening 112. The flange 113 is located on a first side of the edge of the opening 112 close to the accommodating cavity 111, the second reinforcing rib 115 is located on a second side of the edge of the opening 112 away from the accommodating cavity 111, and an outer shape of the flange 113 and an outer shape of the second reinforcing rib 115 match the shape of the edge of the opening 112. For instance, when the edge of the opening 112 has an O-shaped structure, a D-shaped structure, a runway-shaped structure, a square structure, or a rectangular structure, the flange 113 and the second reinforcing rib 115 each correspondingly have an O-shaped structure, a D-shaped structure, a runway-shaped structure, a square structure, or a rectangular structure.

As shown in FIGS. 1, 4, and 5, in one embodiment, the drum 100 comprises a drum body 110 and a rotating member 120. The opening 112 is defined on the circumferential sidewall of the drum body 110. The rotating member 120 comprises a rotating body, a toothed portion 121, and a smooth portion 122. The toothed portion 121 and the smooth portion 122 are disposed along a circumferential direction of the rotating body. The rotating body is connected to the drum body 110 to form the accommodating cavity 111. The toothed portion 121 is meshed with a driving gear of the base, and the driving gear is configured to drive the rotating member 120 to rotate, so as to drive the drum 100 to rotate around the rotation axis H.

Specifically, the driving gear is driven by a driver 13 of the base, and the driver 13 is for example, a rotating motor or a driving motor. Of course, a speed reduction mechanism, such as a speed reduction gear mechanism or a speed reduction worm gear mechanism, may be disposed between the driving gear and the driver 13 to reduce the speed and increase torque, so as to increase an output torque of the driving gear, thereby ensuring that the drum 100 has sufficient power to rotate.

In the embodiment, by providing the rotating member 120 having the smooth portion 122 and the toothed portion 121, the toothed portion 121 is meshed with the driving gear of the base to enable the driving gear to transmit torque to the drum 100, and the smooth portion 122 limits a rotation of the drum 100 so as to limit a rotation angle of the drum 100. For instance, the rotation angle of the drum 100 is limited to a range between 90° and 270°, which facilitates screening out clumped cat litter and pet waste.

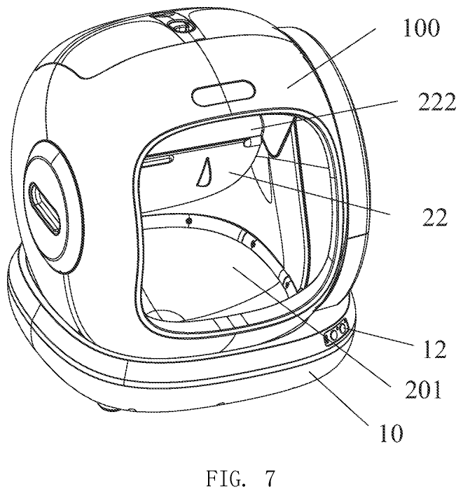

As shown in FIGS. 7-12, the driver 13 is configured to drive the drum 100 to rotate The driver 13 outputs rotational motion, causing the drum 100 to rotate. A rotation of the drum 100 is generally a self-rotation. That is, a rotation axis of the drum 100 is a central axis of the drum 100. A position of the drum 100 relative to the base is unchanged while rotating, ensuring stability of the cat litter box during rotation.

The drum 100 further includes a partition assembly 22. The partition assembly 22 divides the accommodating cavity 111 into a first cavity 201 and a second cavity 202.

The first cavity 201 provides a place for the pet to stay. The first cavity 201 provides an area for the pet to urinate and defecate. The first cavity is further configured to accommodate cat litter. After the pet defecates, the cat litter clumps around feces to form a clump. For ease of description and understanding, the clump is referred to as waste. In other words, when the pet needs to defecate, the pet enters the first cavity 201, where the cat litter is located inside and, due to gravity, at a lowest position of the first cavity. The partition assembly 22 divides the accommodating cavity 111 into two independent cavities (i.e., the first cavity and the second cavity), thereby reducing a risk of the cat being pinched.

The second cavity 202 comprises a waste collecting compartment 2022 and a litter collecting compartment 2021 spaced apart from the waste collecting compartment 2022. The waste collecting compartment 2022 is configured to collect the waste and is also configured to collect the cat litter that needs to be replaced. In short, the waste collecting compartment 2022 is configured to collect items to be discarded. The litter collecting compartment 2021 collects the cat litter sieved during each waste collection, and the cat litter is recycled.

The partition assembly 22 comprises a partition plate 222, a litter guide plate 223, a litter sieve 221, and an emptying plate 224. The partition plate 222, the litter guide plate 223, and the litter sieve 221 jointly divide the accommodating cavity 111 into the first cavity 201 and the second cavity 202. The partition plate 222 is disposed between the litter guide plate 223 and the litter sieve 221. The litter sieve 221 has mesh holes, allowing the cat litter to pass through, but preventing the waste from passing through. The litter sieve 221 is configured as a litter inlet of the litter collecting compartment. That is, the cat litter is allowed to enter the litter collecting compartment 2021 from the first cavity 201 through the litter sieve 221. The litter guide plate 223 is movable relative to the partition plate 222. The litter guide plate 223 is configured as a door of a waste inlet 203 of the waste collecting compartment. When the litter guide plate 223 moves relative to the partition plate 222, the waste inlet 203 of the waste collecting compartment 2022 is exposed. That is, the first cavity 201 is communicated with the waste collecting compartment 2022, and the waste then falls into the waste collecting compartment 2022 from the first cavity through the litter guide plate 223. The emptying plate 224 is configured to shield the litter sieve 221, so as to isolate the first cavity 201 and the litter collecting compartment 2021. In this way, when the cat litter flows to the emptying plate 224, the cat litter does not fall into the litter collecting compartment 2021.

In an initial state of the cat litter box, part of inner walls of the first cavity 201 is located at the lowest point of the accommodating cavity 111, and the cat litter is located at the lowest point of the accommodating cavity 111 under gravity. Therefore, the waste collecting compartment 2022 is located on one side of the drum 100, making it convenient for the pet owner to open the waste collecting compartment 2022 and clean up the waste.

When it is necessary to collect the waste, the driver 13 rotates the drum 100 in a first direction, causing the litter sieve 221 to gradually rotate to a horizontal position. The cat litter passes through the litter sieve 221 into the litter collecting compartment 2021, while the waste, due to its larger size, remains on the litter sieve 221. The drum 100 continues to rotate in the first direction, and the litter guide plate 223 moves until the litter guide plate 223 gradually rotates to be roughly horizontal or fully horizontal. The waste pushes open the litter guide plate 223 and enters the waste collecting compartment 2022. Then, the driver 13 rotates the drum 100 in a second direction until the cat litter box returns to the initial state. At this point, the cat litter returns from the litter collecting compartment 2021 back to the first cavity 201 through the emptying plate, so that the cat litter is recycled. The second direction is opposite to the first direction. For instance, when the first direction is clockwise, the second direction is counterclockwise.

When it is necessary to replace the cat litter, the emptying plate 224 covers the litter sieve 221. The driver 13 rotates the drum 100 in the first direction, and the litter guide plate 223 moves until the litter guide plate 223 is roughly or horizontally positioned. The cat litter pushes open the litter guide plate 223 and enters the waste collecting compartment 2022. Then, the driver 13 rotates the drum 100 in the second direction until the cat litter box returns to the initial state, allowing the pet owner to add new cat litter into the first cavity 201.

The waste collecting compartment 2022 may be cleaned periodically or after each waste collection, either by replacing a trash bag or by emptying the waste collecting compartment 2022 manually.

In the embodiment, the cat litter box comprises the base 10, the driver 13, and the drum 100. The drum 100 comprises the drum body 110 and the partition assembly 22. The partition assembly 22 divides the accommodating cavity 111 of the drum body 110 into the first cavity 201 and the second cavity 202. The first cavity 201 provides a staying space for the pet such as the cat, while the second cavity 202 comprises the waste collecting compartment 2022 and the litter collecting compartment 2021 that are spaced apart from each other. The partition assembly 22 comprises the partition plate 222, the litter guide plate 223, the litter sieve 221, and the emptying plate 224. The litter guide plate 223 is configured as the door of the waste inlet 203 of the waste collecting compartment 2022, and the litter sieve 221 is configured as the litter inlet of the litter collecting compartment 2021. In the initial state, part of the inner wall of the first cavity 201 is located at the lowest point of the accommodating cavity 111, and the cat litter is located at the lowest point under the action of gravity. Therefore, the waste collecting compartment 2022 is located on the side of the drum 100, making it convenient for the pet owner to open the waste collecting compartment 2022 and clean up the feces.

When the pet defecates, the cat litter is placed at the bottom portion of the first cavity 201 After the pet defecates, during a cleaning process, the driver 13 rotates the drum 100 in the first direction. As the litter sieve 221 rotates to approach the bottom of the first cavity 201, the cat litter passes through the litter sieve 221 into the litter collecting compartment 2021, while larger waste remains on the litter sieve 221, thereby separating the cat litter from the waste. After separation, the drum 100 continues to rotate, causing the waste to slide along a surface of the litter sieve 221 and a surface of the partition plate 222 toward the litter guide plate 223. The litter guide plate 223 is then pushed open, allowing the waste to enter the waste collecting compartment 2022. Subsequently, the driver 13 rotates the drum 100 in a second direction to return the partition assembly 22 to an initial position, and the cat litter falls back into the first cavity 201 under gravity. When it is necessary to replace the cat litter, the emptying plate 224 is positioned to cover the litter sieve 221. The driver 13 then rotates the drum 100 in the first direction, causing the cat litter to slide along the surface of the emptying plate 224 and the surface of the partition plate 222 toward the litter guide plate 223. The litter guide plate 223 is pushed open, allowing the cat litter to enter the waste collecting compartment 2022.

In the cat litter box of the present disclosure, when the drum 100 is in the initial position, the waste collecting compartment 2022 is located on one side of the drum 100, thereby reducing a height of the base 10 and making it easier for the pet to enter an interior of the drum 100 Furthermore, the partition assembly 22 divides the accommodating cavity 111 into the first cavity 201 and the second cavity 202, and there is no rolling clamping structure inside the accommodating cavity 111, which avoids the risk of pinching injury to the pet. Additionally, by providing the emptying plate 224, the cat litter is allowed to be automatically transferred to the waste collecting compartment 2022, eliminating a need for manual replacement of the cat litter.

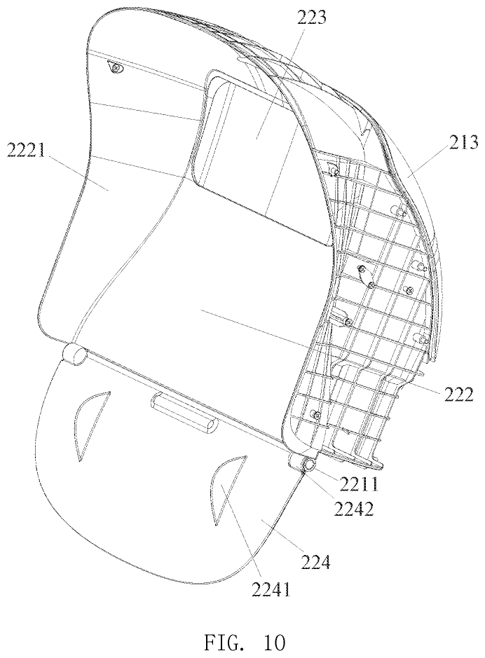

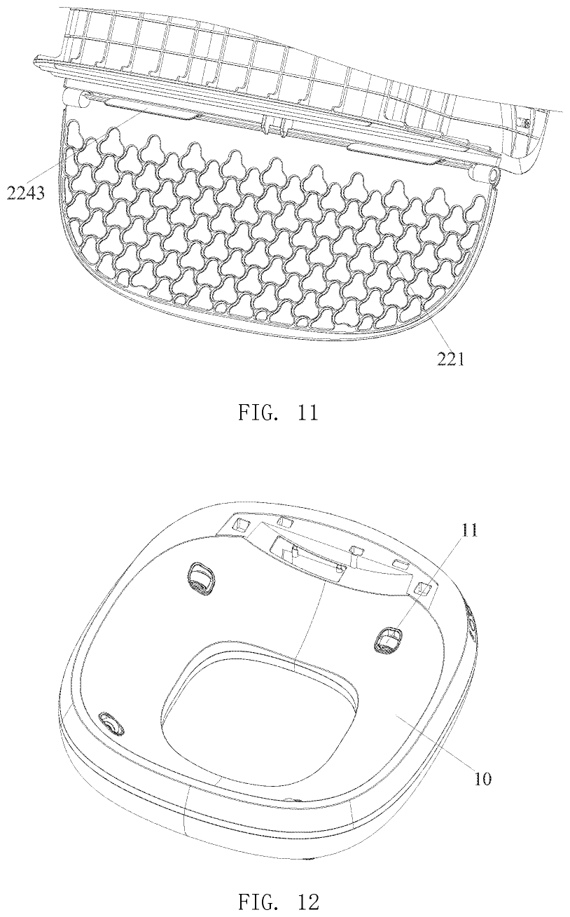

In some embodiments, as shown in FIGS. 10-11, the emptying plate 224 is detachably connected to the litter sieve 221. The pet owner is allowed to either install the emptying plate 224 to the litter sieve 221 or remove the emptying plate 224, depending on different operational requirements.

Specifically, when waste collection is required, that is, when it is necessary to separate the waste from the cat litter, the emptying plate 224 is not installed on the litter sieve 221. The cat litter passes through the litter sieve 221, achieving the separation of the waste and the cat litter. When it is necessary to replace the cat litter, the emptying plate 224 is installed on the litter sieve 221. During the rotation of the drum 100, the cat litter does not pass through the litter sieve 221 into the litter collecting compartment 2021 but is transferred directly into the waste collecting compartment 2022.

In some embodiments, as shown in FIGS. 10-11, first engaging portions are disposed on the litter sieve 221. Second engaging portions are disposed on the emptying plate 224. The first engaging portions are respectively engaged with the second engaging portions. The first engaging portions are recessed structures, protruding structures, or a combination of both. Similarly, the second engaging portions are recessed structures, protruding structures, or a combination of both.

Through mutual cooperation of the first engaging portions and the second engaging portions, the emptying plate 224 is snapped with the litter sieve 221, thereby achieving a detachable connection therebetween. Furthermore, during the installation or removal of the emptying plate 224, no tools are required. That is, the emptying plate 224 is allowed to be installed or detached by hand.

In some embodiments, as shown in FIGS. 10-11, one group of a group of the first engaging portions and a group of the second engaging portions is a group of rotating shafts 2211, and the other group is shaft holes 2242, so that the emptying plate 224 is rotatable relative to the litter sieve 221. There are two cases for the first engaging portions and the second engaging portions. In a first case, the first engaging portions are the rotating shafts 2211, and the second engaging portions are the shaft holes 2242. In a second case, the first engaging portions are the shaft holes 2242, and the second engaging portions are the rotating shafts 2211.

When the first engaging portions are engaged with the second engaging portions, the rotating shafts 2211 and the shaft holes 2242 are coaxially disposed, and cross-sections of the rotating shafts and cross-sections of the shaft holes 2242 are circular. Therefore, the emptying plate 224 is rotatable relative to the litter sieve 221. In this way, when installing the emptying plate 224, the emptying plate 224 is first positioned at a certain angle relative to the litter sieve 221, with the first engaging portions respectively aligned with the second engaging portions. Then, the hand of the pet owner reaches between the emptying plate 224 and the litter sieve 221, facilitating the application of force to connect the first engaging portions to the second engaging portions. After the first engaging portions are connected to the second engaging portions, the emptying plate 224 is rotated relative to the litter sieve 221 until the emptying plate 224 covers the litter sieve 221. Similarly, when removing the emptying plate 224, the emptying plate 224 is first rotated relative to the litter sieve 221 to create an angle therebetween, making it easier for the pet owner to apply force and disengage the first engaging portions and the second engaging portions.

Optionally, there are two first engaging portions and two second engaging portions. The two first engaging portions are disposed on an edge of the litter sieve 221 close to the partition plate 222, and the two second engaging portions are disposed on an edge of the emptying plate 224 close to the partition plate 222. Therefore, a connection between the emptying plate 224 and the litter sieve 221 is stable.

Optionally, at least one grip portion 2241 for handling is disposed on one side of the emptying plate 224 facing away from the litter sieve 221. The at least one grip portion 2241 is understood as a protruding structure extending from a surface of the emptying plate 224. The at least one grip portion 2241 is configured to be gripped by the pet owner to facilitate holding, installation, or removal of the emptying plate 224 by hand.

The at least one grip portion 2241 is a rib extending from the surface of the emptying plate 224. The at least one grip portion 2241 comprises one or more grip portions 2241, and the number and positions of the at least one grip portion 2241 are not limited thereto.

In some embodiments, as shown in FIG. 12, at least one hooking portion 2243 is disposed on one side of the emptying plate 224 close to the partition plate 222. When the emptying plate 224 is installed on the litter sieve 221, the at least one hooking portion 2243 is inserted between the partition plate 222 and the litter sieve 221.

In the embodiment, by providing the at least one hooking portion 2243 on the emptying plate 224, the emptying plate 224 is easily installed on the litter sieve 221. During installation, the at least one hooking portion 2243 is simply hooked onto the litter sieve 221, making both attachment and removal effortless.

In some embodiments, the at least one hooking portion 2243 is a sheet that is easily inserted between the litter sieve 221 and the partition plate 222.

In some embodiments, the at least one hooking portion 2243 comprises a plurality of hooking portions 2243. The plurality of hooking portions 2243 are disposed sequentially along a length direction of a gap between the partition plate 222 and the litter sieve 221.

In some embodiments, as shown in FIGS. 7, 11, and 12, one side of the litter sieve 221 close to the partition plate 222 is rotatably connected to the partition plate 222. A stop portion 215 is disposed on one side of the drum body 110 where the litter sieve 221 faces the litter collecting compartment 2021. When the cat litter box is in the initial state, the litter guide plate 223, the partition plate 222, and the litter sieve 221 are disposed from top to bottom. One side of the litter sieve 221 close to the partition plate 222 is a top side of the litter sieve 221. That is, the top side of the litter sieve 221 is pivotally connected to the partition plate 222. Meanwhile, the stop portion 215 is disposed on the inner wall of the drum body 110. The stop portion 215 is configured to stop the litter sieve 221, thereby limiting a rotation of the litter sieve 221. Since the stop portion 215 is disposed on one side of the litter sieve 221 facing the litter collecting compartment 2021, the stop portion 215 serves to block any movement of the litter sieve 221 toward the interior of the litter collecting compartment 2021. Namely, the litter sieve 221 is only allowed to rotate in a direction away from the litter collecting compartment 2021.

In the embodiment, the litter sieve 221 is rotatably connected with the partition plate 222, and the stop portion 215 is disposed on the drum body 110, so that the litter sieve 221 is only allowed to rotate in a direction away from the litter collecting compartment 2021. In this way, it ensures that during waste collection, the litter sieve 221 remains stably positioned at an edge of the litter collecting compartment 2021, so that litter sieving and waste collection are not affected. After waste collection, the litter sieve 221 is manually rotated to open the litter collecting compartment 2021, allowing the cat litter to quickly fall back into the first cavity 201, preventing excessive cat litter residue from remaining in the litter collecting compartment 2021.

In some embodiments, as shown in FIG. 11, one side of the litter guide plate 223 away from the partition plate 222 is rotatably connected to the drum body 110. When the cat litter box is in the initial state, the litter guide plate 223, the partition plate 222, and the litter sieve 221 are disposed from top to bottom. The one side of the litter guide plate 223 away from the partition plate 222 is a top side of the litter guide plate 223. In other words, a top portion of the litter guide plate 223 is rotatably connected to the drum body 110. In this way, when the waste moves to the litter guide plate 223, the waste directly pushes against the one side of the litter guide plate 223 close to the partition plate 222, so that the waste rapidly enters the waste collecting compartment 2022.

In some embodiments, as shown in FIGS. 10-11, one side of the litter sieve 221 facing the first cavity 201, one side of the partition plate 222 facing the first cavity 201, and one side of the litter guide plate 223 facing the first cavity 201 are smoothly transitioned and jointly form a first surface. The first surface is one of the inner walls of the first cavity 201, while remaining inner walls of the first cavity 201 are part of the inner walls of the drum body 110.

By making the first surface smooth, part of the inner walls of the first cavity 201 is smooth. Furthermore, the remaining inner walls of the first cavity 201 (part of the inner walls of the drum body 110) are typically smooth. In this way, when the pet is inside the first cavity 201, the pet is not pinched or scratched by the inner walls of the first cavity 201, thereby protecting the pet.

In some embodiments, the one side of the litter sieve 221 facing the first cavity 201, the one side of the partition plate 222 facing the first cavity 201, and one side of the litter guide plate 223 facing the first cavity 201 are flat surfaces or curved surfaces, as long as they are smoothly transitioned.

In some embodiments, as shown in FIGS. 7-12, the drum 100 further comprises a waste bin 226. The interior of the waste bin 226 is the waste collecting compartment 2022. The waste bin 226 may be used by attaching a trash bag or may be used directly. A waste chamber is enclosed by one side of the partition plate 222 facing the waste bin 226 and one side of the drum body 110 facing the waste bin 226. The waste bin 226 is placed inside this waste chamber and is allowed to be removed from the waste chamber, making it convenient for the pet owner to clean the waste.

In some embodiments, the drum 100 further comprises a dividing plate 225 disposed in the second cavity 202. The dividing plate 225 divides the second cavity 202 into the waste collecting compartment 2022 and the litter collecting compartment 2021. In other words, the dividing plate 225 divides the second cavity 202 into the waste chamber and the litter collecting compartment 2021. A first side of the dividing plate 225 is connected to the partition plate 222, a second side of the dividing plate 225 (opposite to the first side of the dividing plate) extends to the inner walls of the drum body 110.

Optionally, the dividing plate 225 is integrally formed with the partition plate 222, which reduces the number of parts of the drum 100, simplifies the installation of the drum 100, and streamlines an internal structural layout of the drum 100.

In some embodiments, a gap between the drum body 110 and the base 10 is less than 5 mm, such as 4 mm or 3 mm. The gap between the drum body 110 and the base 10 is understood as a minimum clearance between the drum body 110 and the base 10. If the gap is too large, there is a risk that pet hair or limbs could easily get caught between the drum body 110 and the base 10, posing the risk of hurting the pet. By setting the gap between the drum body 110 and the base 10 to less than 5 mm, the risk of the cat being pinched is avoided.

In some embodiments, as shown in FIG. 7, a gravity sensor 12 configured to detect a weight change of the drum 100 is disposed on the base 10. The weight change of the drum 100 does not refer to a change in a weight of the drum itself, but rather to a change in a total weight of the drum 100 and items placed therein. For example, a change in a weight of the cat litter may cause a change in the weight of the drum 100, and a presence or absence of the pet inside the drum 100 also causes a change in the weight of the drum 100.

In the embodiment, by providing the gravity sensor 12, it is detected whether the pet enters the drum 100. When the pet is detected, the drum 100 is stopped to prevent the cat from being pinched.

In some embodiments, edges and corners of the drum body 110 are chamfered, ensuring that surfaces of the drum body 110 are smooth to prevent the cat from being pinched.

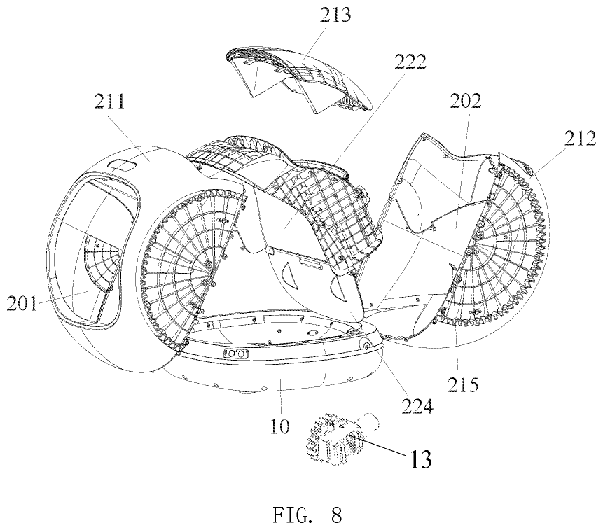

In some embodiments, as shown in FIGS. 8-11, the drum body 110 comprises a first drum section 211, a second drum section 212, and a cover 213. The first drum section 211 has a pet entrance for the pet to enter. The cover 213 covers an outlet of the waste collecting compartment 2022. The partition plate 222 extends along an inner wall of the first drum section 211 and/or an inner wall of the second drum section 212 to form an extension portion 2221. The extension portion 2221 is fixed to the first drum section 211 and/or the second drum section 212. The first drum section 211, the second drum section 212, and the cover 213 jointly enclose the drum body 110 and define the accommodating cavity 111. When the pet needs to defecate, the pet enters the first cavity 201 through the opening 112 defined on the first drum section 211. When it is necessary to clean the waste collecting compartment 2022, the cover 213 is opened to expose the waste collecting compartment, facilitating the cleaning of collected waste. The extension portion 2221 is integrally formed with the partition plate 222. The extension portion 2221 is fixed to the inner wall of the first drum section 211 and/or the inner wall of the second drum section 212. By fixing the extension portion, the partition plate 222 is fixed in place, which facilitates an installation of the partition plate 222.

In an initial state, the opening 112 is located at a bottom portion of the drum body, and a plane where a geometric center of the opening 112 lies is parallel to a rotation axis of the drum body.

In the embodiment, the drum body 110 is composed of the first drum section 211, the second drum section 212, and the cover 213, so that the drum body 110 is easy to manufacture and an installation of the partition assembly 22 is also easy. The extension portion 2221 allows the partition assembly 22 to fit snugly against inner walls of the drum body 110, further reducing the risk of the cat being pinched, and makes it easy to install the partition assembly 22 on the inner wall of the drum body 110.

In some embodiments, the extension portion 2221 fits against the inner wall of the drum body 110, making it easier for the extension portion 2221 to be fixed to the drum body. Specifically, the extension portion 2221 may fit against the inner wall of the first drum section 211, or the extension portion 2221 may fit against the inner wall of the second drum section 212, or the extension portion 2221 may fit against the inner wall of the first drum section 211 and the inner wall of the second drum section 212.

In some embodiments, the driver 13 is a motor or an engine.

In some embodiments, as shown in FIG. 12, roller assemblies 11 are disposed on one side of the base 10 facing the drum 100. The roller assemblies 11 are configured to support the drum 100. It is understood that the roller assemblies 11 are disposed on a top surface of the base 10. The roller assemblies 11 support the drum 100, and rotation axes of the roller assemblies 11 are parallel to the rotation axis of the drum 100. The roller assemblies 11 provide rotational guidance and reduce friction between the base 10 and the drum 100.

In the embodiment, by providing the roller assemblies 11 on the base 10, the drum 100 is supported, the rotation of the drum 100 is guided, and the friction between the base 10 and the drum 100 is reduced. In this way, bearings are eliminated to reduce the manufacturing cost of the cat litter box.

In some embodiments, there are four roller assemblies 11. The four roller assemblies 11 are respectively disposed on four corners of the base 10, so that the drum body is stably supported.

In the description of the present disclosure, the description of reference terms “one embodiment”, “some embodiments”, “examples”, “particular examples”, “some examples”, etc. mean that particular features, structures, materials, or characteristics described in connection with the embodiments or examples are included in at least one embodiment or example of the present disclosure. In the specification, schematic representations of the above terms do not necessarily refer to the same embodiment or example. Furthermore, the specific features, structures, materials, or characteristics described may be combined in any suitable manner in any one or more embodiments or examples. Furthermore, those skilled in the art may combine and combine different embodiments or examples and features of different embodiments or examples described in this specification unless they are inconsistent with each other.

Although the embodiments of the present disclosure are shown and described above, it can be understood that the above-mentioned embodiments are illustrative and should not be regarded as limitations of the present disclosure. Those of ordinary skill in the art can make changes, modifications, substitutions, and variations to the above-mentioned embodiments within the scope of the present disclosure.

What is claimed is:

1. A cat litter box, comprising:
a base; and
a drum rotatably disposed on the base;
wherein the drum defines an accommodating cavity, and a circumferential sidewall of the drum defines an opening communicating with the accommodating cavity;
wherein in a plane perpendicular to a rotation axis of the drum, a first opening angle of the opening is α, and in a plane where the rotation axis of the drum is located, a second opening angle of the opening is β, 70°≤α≤120°, and 70°≤β≤120°.

2. The cat litter box according to claim 1, wherein a flange is disposed along a circumferential direction of the opening, the flange is smoothly connected to an edge of the opening, and the flange extends in a direction toward the accommodating cavity.

3. The cat litter box according to claim 2, wherein first reinforcing ribs are spaced apart from each other along the circumferential direction of the opening, and each of the plurality of first reinforcing ribs is connected between the flange and a cavity wall of the accommodating cavity.

4. The cat litter box according to claim 2, wherein the flange comprises a first flange portion and a second flange portion, the first flange portion is of a U shape, the second flange portion is configured for a pet to step on, the first flange portion is smoothly connected to the second flange portion, and an extension distance of the second flange portion in the direction toward the accommodating cavity is greater than an extension distance of the first flange portion in the direction toward the accommodating cavity.

5. The cat litter box according to claim 4, wherein the extension distance of the first flange portion in the direction toward the accommodating cavity is L₁, and 8 mm≤L₁≤18 mm.

6. The cat litter box according to claim 4, wherein the extension distance of the second flange portion in the direction toward the accommodating cavity is L₂, and 25 mm≤L₂≤50 mm.

7. The cat litter box according to claim 1, wherein the edge of the opening comprises a first edge portion, a second edge portion, a third edge portion, and a fourth edge portion, the first edge portion and the second edge portion are disposed opposite to each other, the third edge portion and the fourth edge portion are disposed opposite to each other, the third edge portion is smoothly connected between the first edge portion and the second edge portion, and the fourth edge portion is smoothly connected between the first edge portion and the second edge portion.

8. The cat litter box according to claim 7, wherein each of the third edge portion and the fourth edge portion is arched in a direction away from the accommodating cavity.

9. The cat litter box according to claim 7, wherein a portion of the first edge portion away from the second edge portion, a portion of the third edge portion away from the second edge portion, and a portion of the fourth edge portion away from the second edge portion enclose to form a first U-shaped structure; or
a portion of the second edge portion away from the first edge portion, a portion of the third edge portion away from the first edge portion, and a portion of the fourth edge portion away from the first edge portion are enclosed to form a second U-shaped structure.

10. The cat litter box according to claim 1, wherein a second reinforcing rib is disposed along a circumferential direction of the opening, the second reinforcing rib is smoothly connected to the edge of the opening, and the second reinforcing rib extends in a direction away from the accommodating cavity.

11. The cat litter box according to claim 1, wherein the cat litter box further comprises a partition assembly disposed in the drum body;
wherein the partition assembly divides the accommodating cavity into a first cavity and a second cavity, and the first cavity is communicated with the opening and is configured for a pet to stay in;
wherein a waste collecting compartment and a litter collecting compartment are defined in the second cavity, the waste collecting compartment and the litter collecting compartment are spaced apart from each other, the litter collecting compartment is configured to store cat litter, and the waste collecting compartment is configured to collect pet waste.

12. The cat litter box according to claim 1, wherein the partition assembly comprises a partition plate, a litter guide plate, a litter sieve, and an emptying plate;
wherein the partition plate is disposed between the litter guide plate and the litter sieve, and the partition plate, the litter guide plate, and the litter sieve jointly divide the accommodating cavity into the first cavity and the second cavity;
wherein the litter sieve is configured as a litter inlet of the litter collecting compartment, and the litter guide plate is movable relative to the partition plate to communicate the first cavity and the waste collecting compartment;
wherein the litter guide plate is a door of a waste inlet of the waste collecting compartment, and the emptying plate is configured to cover the litter sieve so as to isolate the first cavity and the litter collecting compartment.

13. The cat litter box according to claim 12, wherein the emptying plate is detachably connected to the litter sieve.

14. The cat litter box according to claim 12, wherein one side of the litter sieve close to the partition plate is rotatably connected to the partition plate, and a stop portion is disposed on one side of the drum body where the litter sieve faces the litter collecting compartment.

15. The cat litter box according to claim 1, wherein a gap between the drum body and the base is less than 5 mm.
